(19) United States
(12) Patent Application Publication
(10) Pub. No.: US 2004/0252900 A1
(43) Pub. Date: Dec. 16, 2004

(54) Spatial scalable compression

(76) Inventor: Wilhelmus Hendrikus Alfonsus Bruls, Eindhoven (NL)

Correspondence Address: Corporate Patent Counsel, Philips Electronics North Americas Corporation, P.O. Box 3001, Briarcliff Manor, NY, 10510, US

(21) Appl. No.: 10/493,265

(22) PCT Filed: Oct. 21, 2002
(86) PCT No.: PCT/IB02/04395

(30) Foreign Application Priority Data
Oct. 26, 2001 (EP) 01204066.3

(51) Int. Cl. G06K 9/36

(52) U.S. Cl. 382/240; 382/239

(57) ABSTRACT

An apparatus and method for performing spatial scalable compression of video information captured in a plurality of frames is disclosed. A base layer encoder uses a first coding standard to encode a bitstream. An enhancement layer encoder uses a second coding standard to encode a residual signal, wherein the residual signal being the difference between the original frames and the upscaled frames from the base layer.

### FIELD OF THE INVENTION

The invention relates to a video encoder/decoder.

### BACKGROUND OF THE INVENTION

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, H.263, and H26L.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

FIG. 1 illustrates a known spatial scalable video encoder 100. The depicted encoding system 100 accomplishes layer compression, whereby a portion of the channel is used for providing a low resolution base layer and the remaining portion is used for transmitting enhancement information, whereby the two signals may be recombined to bring the system up to high-resolution. A high resolution video input Hi-Res is split by splitter 102 whereby the data is sent to a low pass filter 104 and a subtraction circuit 106. The low pass filter 104 reduces the resolution of the video data, which is then fed to a base encoder 108. In general, low pass filters and encoders are well known in the art and are not described in detail herein for purposes of simplicity. The encoder 108 produces a lower resolution base stream which can be broadcast, received and via a decoder, displayed as is, although the base stream does not provide a resolution which would be considered as high-definition.

The output of the encoder 108 is also fed to a decoder 112 within the system 100. From there, the decoded signal is fed into an interpolate and upsample circuit 114. In general, the interpolate and upsample circuit 114 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 106 by subtracting the reconstructed high-resolution stream from the original, unmodified high-resolution stream. The output of the subtraction circuit 106 is fed to an enhancement encoder 116 which outputs a reasonable quality enhancement stream.

### SUMMARY OF THE INVENTION

Although the known layered compression schemes can be made to work quite well, these schemes still have a problem in that the enhancement layer needs a high bitrate. Normally, the bitrate of the enhancement layer is equal to or higher than the bitrate of the base layer. However, the desire to store or broadcast high definition video signals calls for lower bitrates than can normally be delivered by common compression standards. This can make it difficult to introduce high definition on existing standard definition systems, because the recording/playing time becomes too small or the required bandwidth becomes too large. Thus, there is a need for a more efficient spatial scalable compression scheme which reduces the bitrate of the enhancement layer. The invention overcomes at least part of the deficiencies of other known layered compression schemes by using different coding standards in the base encoder and the enhancement encoder.

According to one embodiment of the invention, an apparatus and method for performing spatial scalable compression of video information captured in a plurality of frames is disclosed. A base layer encoder uses a first coding standard to encode a bitstream. An enhancement layer encoder uses a second coding standard to encode a residual signal, wherein the residual signal being the difference between the original frames and the upscaled frames from the base layer. It is preferred that the input to the enhancement coder is modified into a signal with a signal level range of a normal video input signal. Such a modification can be performed by adding a DC-offset, preferably such that the pixel values of the enhancement coder input are shifted to the middle of a predetermined input range.

According to another embodiment of the invention, a method and apparatus for providing spatial scalable compression of a video stream is disclosed. The video stream is downsampled to reduce the resolution of the video stream. The downsampled video stream is encoded using a first encoding standard to produce a base stream. The base stream is decoded and upconverted to produce a reconstructed video stream. The reconstructed video stream is subtracted from the video stream to produce a residual stream. The residual stream is encoded using a second encoding standard and outputs an enhancement stream.

According to another embodiment of the invention, a method and apparatus for decoding compressed video information received in a base stream and an enhancement stream is disclosed. The base stream is decoded using a first encoding standard. The decoded base stream is upconverted to increase the resolution of the decoded base stream. The enhancement stream is decoded using a second encoding standard. The upconverted decoded base stream with the decoded enhancement stream are combined to produce a video output.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram representing a known layered video encoder;

FIG. 2 is a block diagram of a layered video encoder according to one embodiment of the invention;

FIG. 3 is a block diagram of a layered video decoder according to one embodiment of the invention; and

FIG. 4 is a block diagram of a section of an encoder according to one embodiment of the invention.

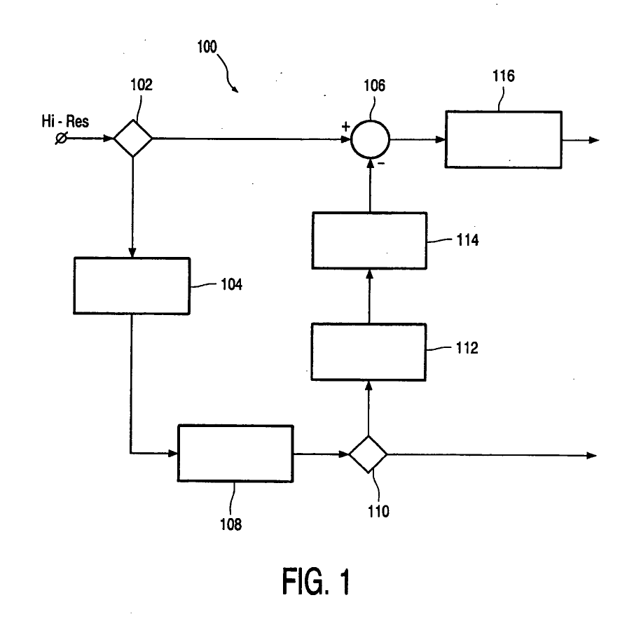

### DETAILED DESCRIPTION OF THE INVENTION

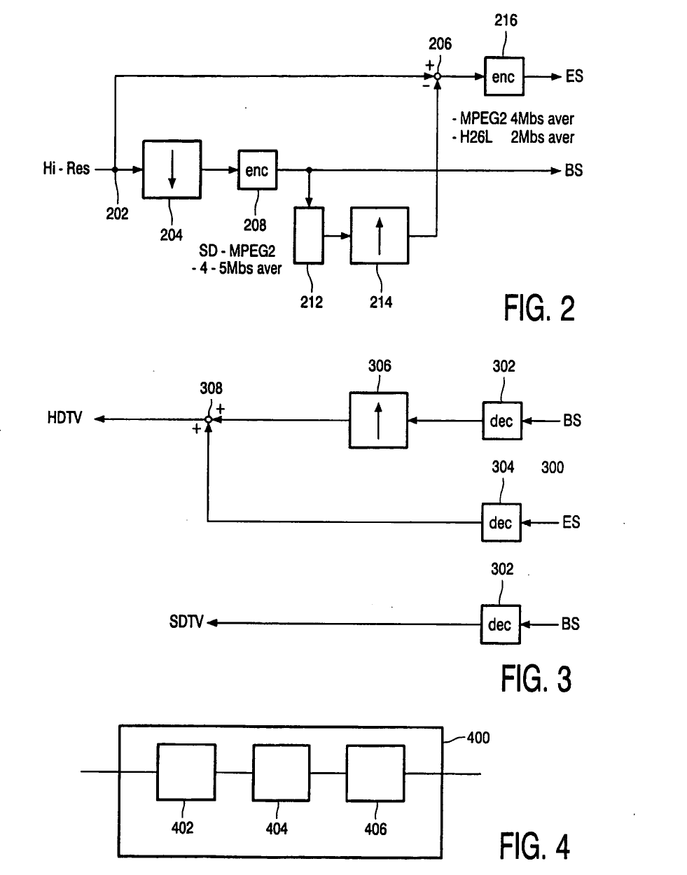

According to one embodiment of the invention, spatial scalable compression is achieved in a layered encoder by using a first coding standard for the base layer and a second coding standard for the enhancement layer. FIG. 2 illustrates a layered encoder 200 which can be used to implement the invention. It will be understood by those skilled in the art that other layered encoders can also be used to implement the invention and the invention is not limited thereto.

The depicted encoding system 200 accomplishes layer compression, whereby a portion of the channel is used for providing a low resolution base layer and the remaining portion is used for transmitting edge enhancement information, whereby the two signals may be recombined to bring the system up to high-resolution. A high resolution video input Hi-RES is split by a splitter 202 whereby the data is sent to a low pass filter 204 and a subtraction circuit 206. The low pass filter 204 reduces the resolution of the video data, which is then fed to a base encoder 208. In general, low pass filters and encoders are well known in the art and are not described in detail herein for purposes of simplicity. The encoder 208 uses a first coding standard to produce a lower resolution base stream BS which can be broadcast, received and via a decoder, displayed as is, although the base stream does not provide a resolution which would be considered as high-definition. The first coding standard can be any video compression scheme such as MPEG-2, MPEG-4, H263, H26L, etc., but the invention is not limited thereto.

The output of the encoder 208 is also fed to a decoder 212 within the system 200. From there, the decoded signal is fed into an interpolate and upsample circuit 214. In general, the interpolate and upsample circuit 214 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 206 by subtracting the reconstructed high-resolution stream from the original, unmodified high-resolution stream to produce a residual signal. The output of the subtraction circuit 206 is fed to an enhancement encoder 216. The enhancement encoder 216 uses a second coding standard, which is different from the first coding standard to encode the residual signal and outputs a reasonable quality enhancement stream ES. The second coding standard can be any video compression scheme such as MPEG-1, MPEG-2, MPEG-4, H263, H26L, H264, proprietary video coding methods, etc, and the invention is not limited thereto. This embodiment offers the possibility to provide a base stream which is compatible with a first coding standard and an enhancement stream which is compatible with a second standard, e.g. an advantageous new standard. In the particular example where an MPEG encoder is used for the base layer and a H26L encoder is used for the enhancement layer, a factor of at least 2 can be gained on the bitrate of the enhancement stream.

FIG. 3 illustrates a decoder 300 for decoding the encoded signals produced by the layered encoder 200. The base stream is decoded in a decoder 302 using the first coding standard. The output of the decoder 302 is a SDTV output. The enhancement stream is decoded in a decoder 304 using the second coding standard. The output of the decoder is combined with the decoded base stream which has been upconverted in an upconverted 306 in an addition unit 308. The output of the addition unit 308 is an HDTV output.

According to another embodiment of the invention, different quantization schemes can also be used in the base encoder and the enhancement encoder. FIG. 4 illustrates a section of an encoder 400 which can be used in both the base encoder and the enhancement encoder. The encoder 400 comprises, among other features, a DCT circuit 402, a quantizer 404 and a variable length encoder 406. The DCT circuit 402 performs DCT processing on the input signal so as to obtain DCT coefficients which are supplied to the quantizer 404. The quantizer 404 sets a quantization step (quantization scale) in accordance with the data storage quantity in a buffer (not illustrated) received as a feedback and quantizes the DCT coefficients from the DCT circuit 402 using the quantization step. The quantized DCT coefficients are supplied to the VLC unit 406 along with the set quantization step. According to one embodiment of the invention, a first quantization scheme is used by the quantizer in the base encoder and a second quantization scheme, which is different from the first quantization scheme, is used by the quantizer in the enhancement encoder. For example, an adaptive (non-uniform within the macroblock of a frame) quantization scheme is used for the base encoder (which is using MPEG-2 encoding) and a uniform (within the macroblock of one frame) quantization scheme is used for the enhancement encoder (which is using H26L encoding).

The above-described embodiments of the invention can be applied to two layer DVDs where the first layer is the SD base layer and the first plus second layer make up the HD-sequence. This method could also be used to gradually introduce HD broadcast in Europe and China, with extending the SD-DVB signal with an enhancement layer. This method could also be applied to store programs layered on a disk for elastic storage.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or-other unit may fulfill the functions of several of the units or circuits recited in the claims.

1. An apparatus for performing spatial scalable compression of video information captured in a plurality of frames, comprising:
a base layer encoder (208) using a first coding standard to encode a bitstream;
an enhancement layer encoder (216) using a second coding standard to encode a residual signal, wherein the residual signal being the difference between the original frames and the upscaled frames from the base layer.

2. The apparatus for performing spatial scalable compression of video information according to claim 1, wherein first and second coding standards are video compression standards.

3. The apparatus for performing spatial scalable compression of video information according to claim 1, wherein the first and second coding standards are selected from the group comprising: MPEG-1, MPEG-2, MPEG-4, H.263, H26L, H264 and video coding methods.

4. The apparatus for performing spatial scalable compression of video information according to claim 1, wherein a first quantization scheme is used in the base encoder and a second quantization scheme is used in the enhancement encoder.

5. The apparatus for performing spatial scalable compression of video information according to claim 4, wherein the first quantization scheme is adaptive quantization.

6. The apparatus for performing spatial scalable compression of video information according to claim 5, wherein the second quantization scheme is uniform quantization.

7. A layered encoder for encoding a video stream, comprising:
a downsampling unit (204) for reducing the resolution of the video stream;
a base encoder (208) for encoding a lower resolution base stream using a first encoding standard;
an upconverting unit (212,214) for decoding and increasing the resolution of the base stream to produce a reconstructed video stream;
a subtractor unit (206) for subtracting the reconstructed video stream from the original video stream to produce a residual signal;
an enhancement encoder (216) for encoding the residual signal from the subtractor unit using a second encoding standard and outputting an enhancement stream.

8. The layered encoder according to claim 7, wherein first and second coding standards are video compression standards.

9. The layered encoder according to claim 7, wherein the first and second coding standards are selected from the group comprising: MPEG-1, MPEG-2, MPEG-4, H.263, H26L, H264, and video coding methods.

10. The layered encoder according to claim 7, wherein a first quantization scheme is used in the base encoder and a second quantization scheme is used in the enhancement encoder.

11. The layered encoder according to claim 10, wherein the first quantization scheme is adaptive quantization.

12. The layered encoder according to claim 11, wherein the second quantization scheme is uniform quantization.

13. A decoder for decoding compressed video information, comprising: a base stream decoder (302) for decoding a received base stream using a first encoding standard;
an upconverting unit (306) for increasing the resolution of the of the decoded base stream;
an enhancement stream decoder (304) for decoding a received enhancement stream using a second encoding standard;
an addition unit (308) for combining the upconverted decoded base stream and the decoded enhancement stream to produce a video output.

14. A method for providing spatial scalable compression of a video stream, comprising the steps of:
downsampling the video stream to reduce the resolution of the video stream;
encoding the downsampled video stream using a first encoding standard to produce a base stream;
decoding and upconverting the base stream to produce a reconstructed video stream;
subtracting the reconstructed video stream from the video stream to produce a residual stream; and
encoding the residual stream using a second encoding standard and outputting an enhancement stream.

15. A method for decoding compressed video information received in a base stream and an enhancement stream, comprising the steps of: decoding the base stream using a first encoding standard;
upconverting the decoded base stream to increase the resolution of the decoded base stream;
decoding the enhancement stream using a second encoding standard; and
combining the upconverted decoded base stream with the decoded enhancement stream to produce a video output.
